(19) United States
(12) Patent Application Publication
(10) Pub. No.: US 2006/0178170 A1
(43) Pub. Date: Aug. 10, 2006

(54) Wireless communication device having battery authentication, and associated method

(75) Inventors: Yong-Woo Chung, Frisco, TX (US); Ronald J. Webb, Plano, TX (US); Sudhindra P. Herle, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/053,453

(22) Filed: Feb. 8, 2005

(51) Int. Cl. H01Q 11/12

(52) U.S. Cl. 455/572; 455/411

(57) ABSTRACT

There is disclosed a wireless communication device having battery authentication and associated method. The wireless communication device comprises a battery compartment and a battery authenticator capable of authenticating an authentic battery received in the battery compartment and capable of rejecting an unauthentic battery received in the battery compartment. A battery authentication server is capable of receiving a rejection notification message from the wireless communication device and capable of transmitting a rejection reply message to the wireless communication device.

### TECHNICAL FIELD OF THE INVENTION

The present invention relates generally to wireless networks and more specifically, to a system and method for providing battery authentication in a wireless communication device.

### BACKGROUND OF THE INVENTION

The use of wireless devices and wireless networks has become increasingly widespread. As the use of wireless communication devices has increased, the number of manufacturers of replacement batteries for wireless communication devices has also increased. However, many replacement batteries for the wireless communication devices are manufactured by unauthorized suppliers, which can have a substantial impact on profits for authorized suppliers.

In addition, batteries manufactured by unauthorized suppliers are counterfeit batteries and may not be produced with the same quality control as those manufactured by authorized suppliers. Therefore, the counterfeit or unauthentic batteries may not meet the same standards for quality as authentic batteries. The unauthentic battery may provide insufficient power and may discharge in a relatively short period of time. As a result, a wireless communication device customer who unknowingly buys an unauthentic battery may be dissatisfied with the quality of the wireless communication devices and may believe the quality defect is from the wireless communication devices manufacturer, rather than the unauthentic battery supplier.

Furthermore, an unauthentic battery may not meet the same standards for safety as an authentic battery. Because of this, unauthentic batteries can pose a substantial safety risk to the wireless communication device user. For example, the Consumer Product Safety Commission has received dozens of reported cases of unauthentic batteries either exploding or catching fire and injuring the user. This can result in bad publicity and possible legal exposure for the manufacturer of the wireless communication device.

Therefore, there is a need in the art for a wireless communication device having a battery authentication apparatus and method to determine whether an authorized supplier manufactured a battery. In particular, there is a need in the art for a wireless communication device that can authenticate a battery without requiring user knowledge or user input, thereby minimizing user error and protecting the user from unauthorized and potentially dangerous batteries.

### SUMMARY OF THE INVENTION

It is an object of the present invention to overcome the above-discussed deficiencies of the prior art, and more specifically it is a primary object of the present invention to provide a wireless communication device having battery authentication and associated method.

It is another object of the present invention to provide a wireless communication device capable of authenticating a battery in a wireless communication network. According to an advantageous embodiment of the present invention, the wireless communication device comprises: 1) a battery compartment capable of receiving a battery and 2) a battery authenticator capable of authenticating an authentic battery received in the battery compartment and rejecting an unauthentic battery received in the battery compartment.

It is still another object of the present invention to provide a wireless communication network capable of authenticating a battery in a wireless communication device. According to an advantageous embodiment of the present invention, the wireless communication network comprises: 1) a wireless communication device capable of authenticating a battery; 2) a battery compartment in the wireless communication device capable of receiving a battery; 3) a battery authenticator in the wireless communication device capable of authenticating an authentic battery received in the battery compartment and rejecting an unauthentic battery received in the battery compartment; and 4) a battery authentication server capable of receiving a rejection notification message from the wireless communication device and capable of transmitting a rejection reply message to the wireless communication device.

It is a further object of the present invention to provide a method of authenticating a battery in a wireless communication device. According to an advantageous embodiment of the present invention, the method comprises the steps of: 1) receiving a battery into a battery compartment of the wireless communication device; 2) detecting the insertion of the battery into the battery compartment; 3) reading a battery signature from an authentication chip of the battery; and 4) generating authentication data to append to the battery signature.

These and other advantages and features of the present invention will become readily apparent to those skilled in the art upon examination of the subsequent detailed description and accompanying drawings. Accordingly additional advantages and features of the present invention and the scope thereof are pointed out with particularity in the claims and form a part hereof.

### BRIEF DESCRIPTION OF THE DRAWINGS

A more complete understanding of the present invention, its preferred embodiments, further objects, and advantages thereof, will become more apparent by reference to the following detailed description taken in conjunction with the accompanying drawings, wherein like reference numbers indicate like elements, and in which:

FIG. 1 illustrates an exemplary wireless network, which provides battery authentication in a wireless communication device according to the principles of the present invention;

FIG. 2 illustrates in greater detail an exemplary wireless communication device having a battery authenticator according to one embodiment of the present invention;

FIG. 3 illustrates in greater detail an exemplary battery having an authentication chip according to one embodiment of the present invention; and

FIG. 4 is a flow diagram illustrating a method for battery authentication in a wireless communication device according to one embodiment of the present invention.

### DETAILED DESCRIPTION OF THE INVENTION

Reference will now be made to the following detailed description of the exemplary embodiments of the present invention. Those skilled in the art will recognize that the present invention provides many inventive concepts and novel features that are merely illustrative, and are not to be construed as restrictive. Accordingly, the specific embodiments discussed herein are given by way of example and do not limit the scope of the present invention.

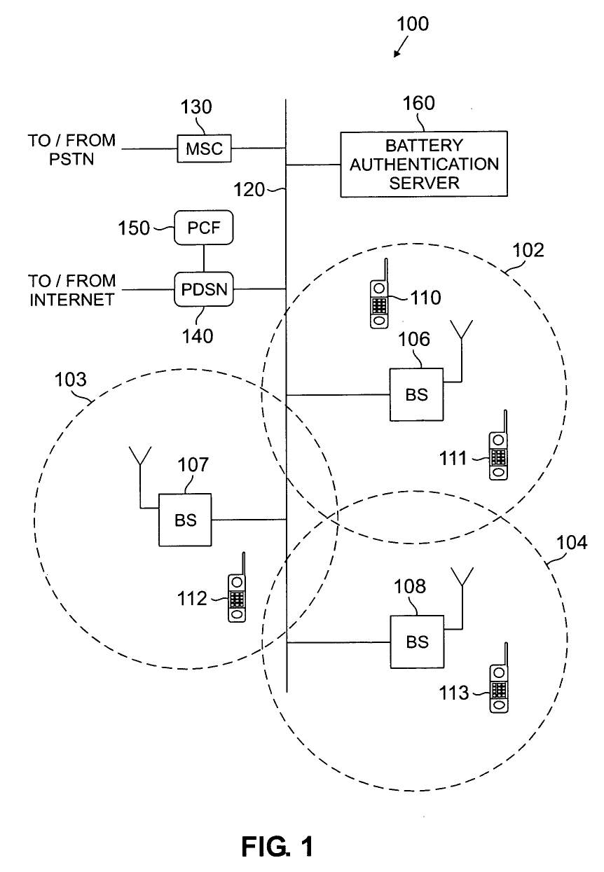

FIG. 1 illustrates exemplary wireless network 100, which provides battery authentication in a wireless communication device according to the principles of the present invention. Wireless network 100 comprises a plurality of cell sites 102-104 in which base stations (BS), such as BS 106, BS 107, and BS 108 are located. Base stations (BS) 106-108 are operable to communicate with a plurality of wireless communication devices (WCD) 110-113 over for example, code division multiple access (CDMA) channels according to the IS-2000-C standard (i.e., Release C of CDMA2000). Wireless communication devices 110-113 may be any suitable wireless devices, including cell phones, PCS handsets, personal digital assistants (PDAs), portable computers, telemetry devices, and the like which are capable of communicating with BS 106, BS 107, and BS 108 via wireless links.

It should be understood that the present invention is not limited to mobile wireless communication devices. Other types of wireless access terminals, including fixed wireless terminals, may be used. For the sake of simplicity and clarity, only wireless communication devices are shown and discussed hereafter. However, it should be understood that the use of the term “wireless communication devices” in the claims and in the description below is intended to encompass both truly wireless communication devices (e.g., cell phones, wireless laptops), stationary wireless terminals (e.g., monitoring devices with wireless capability), or other battery operated devices (e.g., mp3 players, digital recorders).

Dotted lines show the approximate boundaries of cell sites 102-104 in which base stations 106-108 are located. Cell sites 102-104 are shown approximately circular for the purposes of illustration and explanation only. It should be noted that, in a typical wireless network, actual cell sites are irregularly shaped and often in non-uniform configurations, depending on the features of the terrain, such as natural obstructions, man-made obstructions, zoning restrictions, and the like. Cell sites are often subject to other uncontrollable influences.

For simplicity and clarity, only a single base station is shown and described in each respective cell site, as is unique to the present invention or necessary for an understanding of the present invention. In reality, however, one or more of cell sites 102-104, may comprise multiple base stations, each of which communicates with a plurality of mobile stations.

In one embodiment of the present invention, BS 106, BS 107, and BS 108 comprise a base station controller (BSC) and at least one base transceiver subsystem (BTSs). Base station controllers and base transceiver subsystems are well known to those skilled in the art. Base station controllers manage wireless communication resources, including the base transceiver subsystems, for specified cells within a wireless network. A base transceiver subsystem comprises the radio frequency (RF) transceivers, antennas, and other electrical equipment located in each cell site. For the purpose of simplicity and clarity in explaining the operation of the present invention, the base transceiver subsystems in each of cells 102, 103, and 104 and the base station controller associated with each base transceiver subsystem are collectively represented by BS 106, BS 107, and BS 108, respectively.

BS 106, BS 107, and BS 108 transfer voice and data signals between each other and the public switched telephone network (PSTN) (not shown) via communication line 120 and mobile switching center (MSC) 130. BS 106, BS 107, and BS 108 also transfer data signals, such as packet data, with the Internet (not shown) via communication line 120 and packet data server node (PDSN) 140. Packet control function (PCF) unit 150 controls the flow of data packets between base stations 106-108 and PDSN 140. PCF unit 150 may be implemented as part of PDSN 140, as part of base stations 106-108, or as a stand-alone device that communicates with PDSN 140, as shown in FIG. 1. Communication line 120 also provides the connection path to transfer control signals between MSC 130 and BS 106, BS 107, and BS 108 used to establish connections for voice and data circuits between MSC 130 and BS 106, BS 107, and BS 108.

Communication line 120 may be any suitable connection means, including a T1 line, a T3 line, a fiber optic link, or any other type of data connection. The connections on line 120 may transmit analog voice signals or digital voice signals in pulse code modulated (PCM) format, Internet Protocol (IP) format, asynchronous transfer mode (ATM) format, or the like. According to an advantageous embodiment of the present invention, line 120 also provides an IP connection that transfers data packets between BS 106, BS 107, and BS 108. Thus, line 120 may comprise a local area network that provides direct IP connections between BS 106, BS 107, and BS 108 without using PDSN 140.

In the exemplary wireless network 100, WCD 110 and WCD 111 are located in cell site 102 and are operable to communicate with BS 106. WCD 112 is located in cell site 103 and is operable to communicate with BS 107, and WCD 113 is located in cell site 104 and is operable to communicate with BS 108.

In one exemplary embodiment of the present invention, wireless network 100 comprises battery authentication server 160, which is capable of receiving from one of WCD 110-113 a rejection notification message including the battery authentication status. Battery authentication server 160 may forward the rejection notification message to the manufacturer, store the rejection notification message in a server, or transmit a rejection reply message to one of WCD 110-113. The rejection reply message may notify the user of the rejected battery of WCD 110-113. For example, the rejection reply message may inform the user of: (1) a telephone number to call and report the unauthentic battery; (2) provide information on how to purchase an authentic battery; and/or (3) provide or receive any other suitable information to the user.

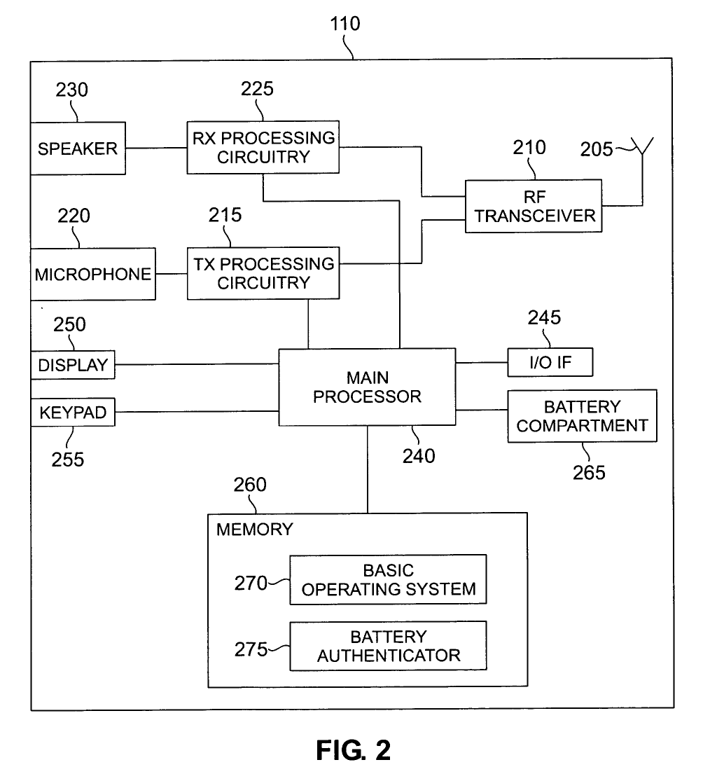

FIG. 2 illustrates in greater detail exemplary wireless communication device (WCD) 110, which comprises a battery authenticator 275 according to one embodiment of the present invention. Wireless communication device (WCD) 110 comprises antenna 205, radio frequency (RF) transceiver 210, transmit (TX) processing circuitry 215, microphone 220, receive (RX) processing circuitry 225, and speaker 230. WCD 110 also comprises main processor 240, input/output (I/O) interface (IF) 245, keypad 250, display 255, memory 260 and battery compartment 265. Memory 260 comprises basic operating system 270 and battery authenticator 275.

RF transceiver 210 receives from antenna 205 an incoming RF signal transmitted by a base station of wireless network 100. RF transceiver 210 down-converts the incoming RF signal to produce an intermediate frequency (IF) or a baseband signal. The IF or baseband signal is sent to RX processing circuitry 225, which produces a processed baseband signal by filtering, decoding, and/or digitizing the baseband or IF signal. RX processing circuitry 225 transmits the processed baseband signal to speaker 230 (i.e., voice data) or to main processor 240 for further processing (e.g., web browsing).

TX processing circuitry 215 receives analog or digital voice data from microphone 220 or other outgoing baseband data (e.g., web data, e-mail, interactive video game data, and the like) from main processor 240. TX processing circuitry 215 encodes, multiplexes and/or digitizes the outgoing baseband data to produce a processed baseband or IF signal. RF transceiver 210 receives the outgoing processed baseband or IF signal from TX processing circuitry 215. RF transceiver 210 up-converts the baseband or IF signal to a RF signal that is transmitted via antenna 205.

According to an exemplary embodiment of the present invention, main processor 240 comprises a microprocessor or microcontroller. Memory 260 is coupled to main processor 240. According to an advantageous embodiment of the present invention, part of memory 260 comprises a random access memory (RAM) and another part of memory 260 comprises a Flash memory, which acts as a read-only memory (ROM).

Main processor 240 executes basic operating system program 270 stored in memory 260 in order to control the overall operation of WCD 110. In one such operation, main processor 240 controls the reception of forward channel signals and the transmission of reverse channel signals by RF transceiver 210, RX processing circuitry 225, and TX processing circuitry 215, in accordance with well-known principles.

Main processor 240 is capable of executing other processes and programs resident in memory 260. Main processor 240 can move data into or out of memory 260, as required by an executing process. Main processor 240 is also coupled to I/O interface 245. I/O interface 245 provides WCD 110 with the ability to connect to other devices, such as laptop computers, handheld computers and the like. I/O interface 245 provides a communication path between these accessories and main controller 240.

Main processor 240 is also coupled to keypad 250 and display unit 255. The operator of WCD 110 uses keypad 250 to enter data into WCD 110. Display 255 allows the operator of WCD 110 to view text and/or graphics via a liquid crystal display. Alternate embodiments may use other types of displays.

In accordance with the principles of the present invention, main processor 240 is also coupled to battery compartment 265. As described in more detail below, main processor 240 detects the insertion of a battery in battery compartment 265 and initiates an authentication process. This process is controlled by battery authenticator 275, which is stored in memory 260 and is executed by main processor 240.

According to an exemplary embodiment of the present invention, main processor 240 may establish a communication link to wireless network 100, and in particular to battery authentication server 160, in response to a rejection of inserted battery 300 into battery compartment 265, via at least one of the BS 106-108 of FIG. 1.

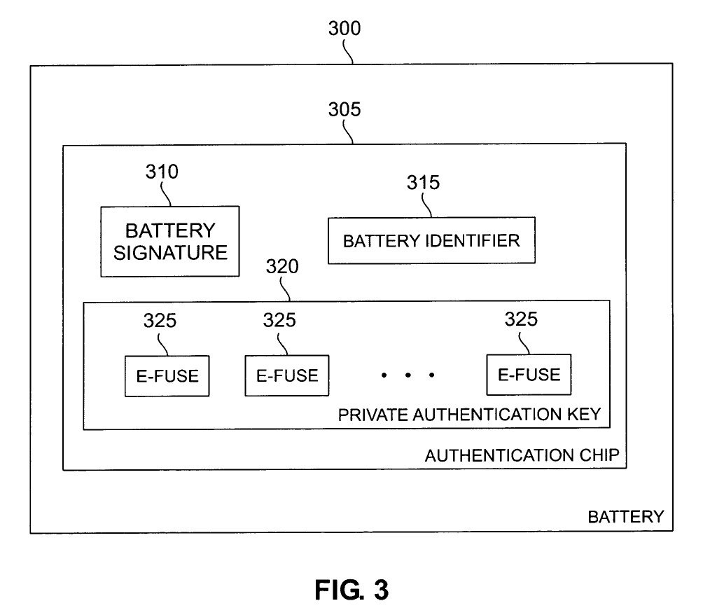

FIG. 3 illustrates in greater detail exemplary battery 300, having an authentication chip 305 according to one embodiment of the present invention. Battery 300 comprises authentication chip 305, which allows wireless communication device (WCD) 110 to authenticate battery 300. Authentication chip 305 comprises battery signature 310, battery identifier 315, and private authentication key 320. Private authentication key 320 comprises a plurality of electrical fuses (e-fuses) 325.

In one embodiment of the present invention, battery signature 310 may be for example, the battery serial number or any other identification number associated with the battery and stored into battery signature 310 at the time of manufacture.

In an exemplary embodiment of the present invention, the manufacturer of battery 300 burns a subset of e-fuses 325 to provide a unique private authentication key 320 for a non-symmetric encryption algorithm for the authentication data. The private authentication key 320 is only known to the manufacturer and may be for example, similar for like phones or like models. The non-symmetric encryption algorithm may be verified by wireless communication device 110 through the use of a public key that corresponds to aforementioned unique private authentication key 320, in the manner described in further detail below.

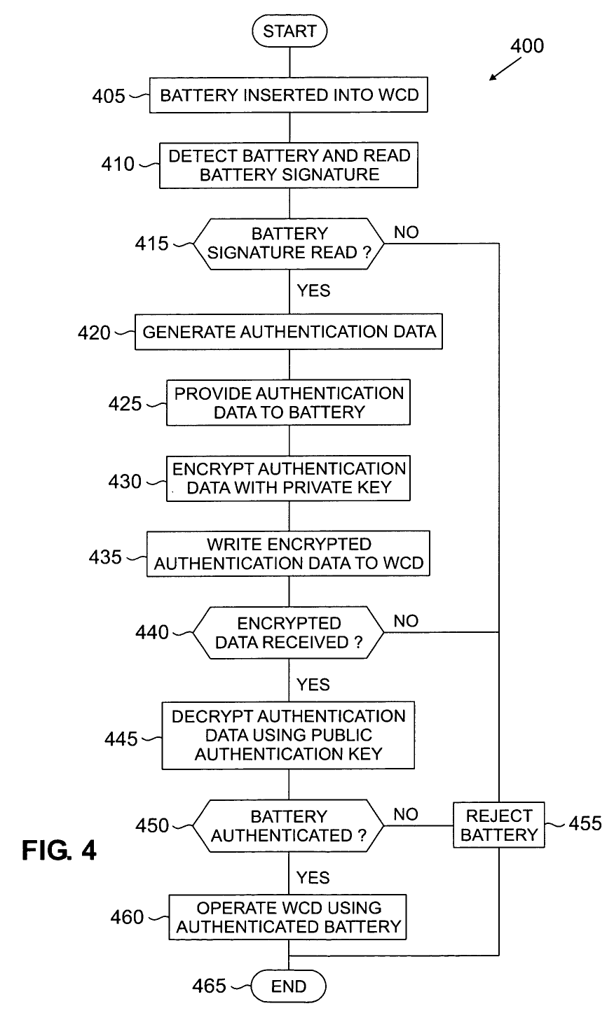

FIG. 4 is a flow diagram 400 illustrating a method for battery authentication in a wireless communication device according to one embodiment of the present invention. Process 400 begins with the insertion of battery 300 in battery compartment 265 of wireless communication device (WCD) 110 (process step 405). Battery authenticator 275 of WCD 110 detects the insertion of battery 300 in battery compartment 265 and reads battery signature 310 (process step 410). Battery signature 310 may be for example the battery serial number or any other type of identification sequence appropriated to battery 300 at time of manufacture. If battery signature 310 does not exist, for example, battery authenticator 275 returns no information within a specified amount of time, battery 300 is rejected (process step 415). If battery authenticator 275 returns a valid battery signature 310, battery authenticator 275 generates authentication data (process step 420). In one exemplary embodiment, the authentication data comprises the generation of random data appended to battery signature 310. Thus, battery authenticator 275 of WCD 110 generates authentication data by a new and unique random generation of data appended to battery signature 310 of battery 300.

Next, battery authenticator 275 writes the authentication data described above to battery 300 for further processing (process step 425). Battery identifier 315 of battery 300 reads the authentication data provided by battery authenticator 275. The authentication data is encrypted with private authentication key 320 comprising a private key provided at time of manufacture (process step 430). In one exemplary embodiment, the manufacturer internally burns a private key into e-fuses 325 at time of manufacture.

Battery identifier 315 writes the encrypted authentication data to battery authenticator 275 of WCD 110 (process step 435). If the encrypted authentication data is not received from battery 300 within a specified amount of time battery 300 is rejected (process step 440). If the encrypted authentication data is received from battery 300 within a specified amount of time, battery authenticator 275 decrypts the encrypted authentication data using a public authentication key (process step 445). Only the public authentication key which corresponds to private authentication key 320 is able to successfully decrypt the encrypted authentication data.

If the public authentication key successfully decrypts the encrypted authentication data, battery authenticator 275 verifies battery 300 as authentic (process step 450). Thereafter, WCD 110 operates using the authenticated battery (process step 460).

If battery authenticator 275 does not verify battery 300 as authentic, battery authenticator 275 rejects battery 300 and may: (1) simply power itself down; (2) display an “unauthorized battery” or any other suitable rejection message prior to powering itself down; (3) provide a rejection notification message to battery authentication server 160 then power itself down; (4) provide a rejection notification message to battery authentication server 160, receive a rejection reply message from battery authentication server 160, and display the rejection reply message on display 255 then power itself down; or (5) perform any other suitable function to prevent the use of the rejected battery 300 in WCD 110 (process step 455). In this way, WCD 110 authenticates battery 300 prior to operating with a potentially unauthentic battery. Thus, authorized suppliers of replacement batteries may be protected from the sale of unauthentic batteries and users of wireless communication devices may be protected from potentially dangerous unauthentic batteries.

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. For use in a wireless communication network, a wireless communication device capable of authenticating a battery, said wireless communication device comprising:
a battery compartment capable of receiving a battery; and
a battery authenticator capable of authenticating an authentic battery received in said battery compartment and rejecting an unauthentic battery received in said battery compartment.

2. The wireless communication device according to claim 1, wherein said battery further comprises an authentication chip capable of communicating with said battery authenticator.

3. The wireless communication device according to claim 2, wherein said battery authenticator reads a battery signature from said authentication chip and generates authentication data to append to said battery signature.

4. The wireless communication device according to claim 3, wherein said battery signature is a battery serial number stored into said battery signature at the time of manufacture.

5. The wireless communication device according to claim 3, wherein said battery authenticator randomly generates said authentication data.

6. The wireless communication device according to claim 3, wherein said authentication chip comprises a battery identifier that reads said authentication data and encrypts said authentication data with a private authentication key.

7. The wireless communication device according to claim 6, wherein said private authentication key comprises a plurality of electrical fuses, and wherein a subset of said electrical fuses is capable of being burned at the time of manufacture to provide a private key for signing the authentication data.

8. The wireless communication device according to claim 6, wherein said battery authenticator decrypts said authentication data using a public authentication key.

9. A wireless communication network, comprising:
a wireless communication device capable of authenticating a battery;
a battery compartment in said wireless communication device capable of receiving a battery;
a battery authenticator in said wireless communication device capable of authenticating an authentic battery received in said battery compartment and rejecting an unauthentic battery received in said battery compartment; and
a battery authentication server capable of receiving a rejection notification message from said wireless communication device and capable of transmitting a rejection reply message to said wireless communication device.

10. The wireless communication network according to claim 9, wherein said battery further comprises an authentication chip capable of communicating with said battery authenticator.

11. The wireless communication network according to claim 10, wherein said battery authenticator reads a battery signature from said authentication chip and generates authentication data to append to said battery signature.

12. The wireless communication network according to claim 11, wherein said battery signature is a battery serial number stored into said battery signature at the time of manufacture.

13. The wireless communication network according to claim 11, wherein said battery authenticator randomly generates said authentication data.

14. The wireless communication network according to claim 11, wherein said authentication chip comprises a battery identifier that reads said authentication data and encrypts said authentication data with a private authentication key.

15. The wireless communication network according to claim 14, wherein said private authentication key comprises a plurality of electrical fuses, and wherein a subset of the electrical fuses is capable of being burned at the time of manufacture to provide a private key for signing the authentication data.

16. The wireless communication network according to claim 14, wherein said battery authenticator decrypts said authentication data using a public authentication key.

17. For use in a wireless communication network, a method of authenticating a battery in a wireless communication device, the method comprising the steps of:
receiving a battery into a battery compartment of said wireless communication device;
detecting the insertion of said battery into said battery compartment;
reading a battery signature from an authentication chip of said battery; and
generating authentication data to append to said battery signature.

18. The method according to claim 17, wherein the step of generating authentication data further comprises:
generating a new and unique random generation of data to append to said battery signature.

19. The method according to claim 17, further comprising:
reading said authentication data;
encrypting said authentication data with a private authentication key; and
decrypting said authentication data using a public authentication key.

20. The method according to claim 19, wherein said battery authenticator rejects said authentication data as unauthentic and further comprises the steps of:
displaying an unauthorized battery rejection message on said wireless communication device;
providing a rejection notification message to a battery authentication server;
receiving a rejection reply message from said battery authentication server; and
powering said wireless communication device off.
